(19) United States
(12) Patent Application Publication
(10) Pub. No.: US 2026/0270763 A1
(43) Pub. Date: Sep. 10, 2026

(54) User equipment and method of handling quality of service rules of a protocol data unit session

(71) Applicant: MEDIATEK INC., Hsin-chu (TW)

(72) Inventor: Yu-Hsin Lin, Hsinchu City (TW)

(73) Assignee: MEDIATEK INC., Hsin-chu (TW)

(21) Appl. No.: 19/166,470

(22) PCT Filed: May 15, 2024
(86) PCT No.: PCT/CN2024/093294

§ 371 Date: Sep. 17, 2025

Related U.S. Application Data
(60) Provisional application No. 63/502,135, filed on May 15, 2023.

(51) Int. Cl. H04W 28/02; H04W 76/30

(52) U.S. Cl. CPC H04W 28/0268; H04W 28/0257; H04W 76/30

(57) ABSTRACT

A user equipment (UE) has a transceiver and a processor coupled to the transceiver. The processor controls the transceiver to receive a non-access stratum (NAS) message for modifying a protocol data unit (PDU) session from a core network. The processor determines UL Network core whether a QoS rule resulted from modification of the PDU session is associated with a guaranteed bit rate (GBR) QoS flow of the PDU session and associated with no QoS flow description. When the QoS rule resulted from the modification of the PDU session is associated with the GBR QoS flow of the PDU session and associated with no QoS flow description and the QoS rule is a default QoS rule, the processor initiates a PDU session release procedure by controlling the transceiver to send a PDU SESSION RELEASE REQUEST message to the core network.

### CROSS REFERENCE TO RELATED APPLICATION

This application claims the benefit of U.S. Provisional Application No. 63/502,135, filed on May 15, 2023. The content of the application is incorporated herein by reference.

### BACKGROUND

### 1. Field of the Invention

The disclosed embodiments relate generally to wireless communication, and, more particularly, to methods and apparatus for handling quality of service (QOS) rules of a protocol data unit (PDU) session.

### 2. Description of the Prior Art

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In the realm of 5th generation wireless systems (5G) technology, PDU (Protocol Data Unit) sessions play a crucial role in enabling seamless data transmission between user devices and networks, such as the internet. These PDU sessions act as dedicated pathways, ensuring the efficient and reliable delivery of application data packet.

The establishment of a Protocol Data Unit (PDU) session is a key process in 5G communication systems. This process involves a coordinated exchange of signaling messages between the user equipment (UE), such as a smartphone or a laptop, and the network. These messages negotiate the Quality of Service (QOS) rules and QoS flow descriptions that will govern the data transmission. The QoS rules and QoS flow descriptions are crucial as they determine how different types of data are treated within the network, ensuring that each data packet gets the appropriate level of service. For example, data packets for a video call might be given higher priority than data packets for a file download.

Once the PDU session is established, the UE and the network can begin exchanging application data packets along the designated pathway. This pathway, or PDU session, acts as a dedicated virtual ‘highway’ for data packets, allowing the data packets to travel from the UE to the network and vice versa. In essence, the establishment of a PDU session is a fundamental step in enabling efficient and reliable data communication in 5G networks. It ensures that data packets are transmitted smoothly and effectively, providing users with a high-quality network experience. As 5G technology continues to evolve, PDU sessions will remain at the forefront, ensuring that the increasingly data-driven world remains connected and responsive.

### SUMMARY

In an embodiment of the present disclosure, a method of handling quality of service (QoS) rules of a protocol data unit (PDU) session is disclosed. The method comprises receiving a non-access stratum (NAS) message for modifying the PDU session from a core network by a user equipment (UE), determining whether a QoS rule resulted from modification of the PDU session is associated with a guaranteed bit rate (GBR) QoS flow of the PDU session and associated with no QoS flow description, and initiating a PDU session release procedure by sending a PDU SESSION RELEASE REQUEST message from the UE to the core network when the QoS rule resulted from the modification of the PDU session is associated with the GBR QOS flow of the PDU session and associated with no QoS flow description and the QoS rule is a default QoS rule.

In another embodiment of the present disclosure, another method of handling QoS rules of a PDU session is disclosed. The method comprises receiving a non-access stratum (NAS) message for modifying the PDU session from a user equipment (UE) by a core network, determining whether a QoS rule resulted from modification of the PDU session is associated with a guaranteed bit rate (GBR) QoS flow of the PDU session and associated with no QoS flow description, and, initiating a PDU session release procedure by sending a PDU SESSION RELEASE COMMAND message from the core network to the UE when the QoS rule resulted from the modification of the PDU session is associated with the GBR QOS flow of the PDU session and associated with no QoS flow description and the QoS rule is a default QoS rule.

In another embodiment of the present disclosure, a user equipment (UE) is disclosed. The UE comprises a transceiver and a processor. The transceiver is configured to receive signals from a core network and transmit signals to the core network. The processor is coupled to the transceiver and configured to control the transceiver to receive a non-access stratum (NAS) message for modifying a protocol data unit (PDU) session from the core network; to determine whether a QoS rule resulted from modification of the PDU session is associated with a guaranteed bit rate (GBR) QoS flow of the PDU session and associated with no QoS flow description; and to initiate a PDU session release procedure by controlling the transceiver to send a PDU SESSION RELEASE REQUEST message to the core network when the QoS rule resulted from the modification of the PDU session is associated with the GBR QOS flow of the PDU session and associated with no QoS flow description and the QoS rule is a default QoS rule.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a communication system according to an embodiment of the disclosure.

FIG. 2 shows an example of the PDU session according to an embodiment of the disclosure.

FIG. 3 shows an example UE-requested PDU session establishment procedure.

FIG. 4 shows an example network-requested PDU session modification procedure.

FIG. 5 shows an example UE-requested PDU session modification procedure.

FIG. 6 shows an example network-requested PDU session release procedure.

FIG. 7 shows an example UE-requested PDU session release procedure.

FIG. 8 shows a QoS rule handling process according to an embodiment of the disclosure.

FIG. 9 shows another QoS rule handling process according to an embodiment of the disclosure.

### DETAILED DESCRIPTION

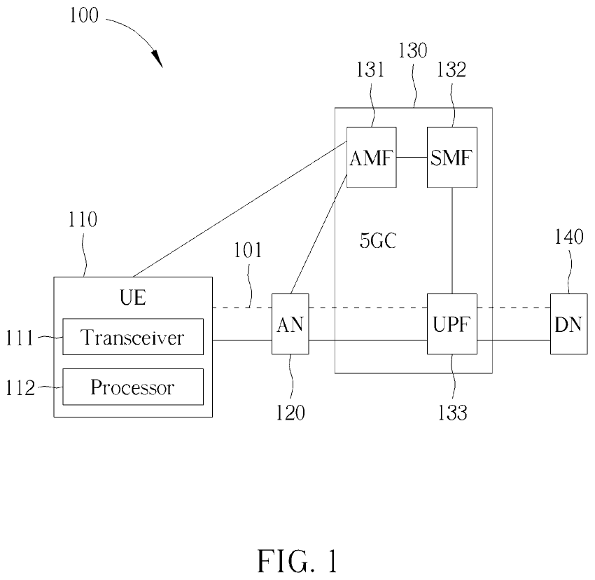

FIG. 1 shows a communication system 100 according to an embodiment of the disclosure. The communication system 100 can be a fifth generation system (5GS) that includes a user equipment (UE) 110, an access network (AN) 120, a core network 130, and a data network (DN) 140. The core network 130 can be a fifth generation core (5GC) having an access and mobility management function (AMF) 131, a session management function (SMF) 132, a user plane function (UPF) 133. The AMF 131, the SMF 132, and the UPF 133 are coupled with each other and can coordinate with each other to establish, modify, or release a protocol data unit (PDU) session 101 for exchanging data units (e.g., IP packets, Ethernet data frames, unstructured data, and the like) between the UE 110 and the DN 140.

The UE 110 can be a mobile phone, a laptop, a vehicle, and the like. The AN 120 can be a 3rd Generation Partnership Project (3GPP) radio network (e.g., a gNB as specified in 3GPP New Radio standards), or a non-3GPP network (e.g., a Wi-Fi, WiMAX, or fixed network). The UE 110 comprises a transceiver 110 and a processor 112. The transceiver 110 may include one or more antennas, and is used to wirelessly receive signals from the core network 130 and transmit signals to the core network 130. The processor 112 is coupled to the transceiver 110 and used to process the signals received by the transceiver 110. The processor 112 invokes different functional modules and circuits to perform features in the UE 110. The core network 130 is specified in 3 5G standards. The AMF 131 can be configured to forward session management related signaling messages between the SMF 132 and the UE 110. The SMF 132 is configured to exchange signaling messages with the UE 110, the AN 120, and the UPF 133 to perform session management functions, such as establishment, modification, and release of the PDU session 101.

In operation, 5GS session management (5GSM) processes can be performed over a non-access stratum (NAS) signaling connection between the UE 110 and the AMF 131 for PDU session handling in the UE 110 and in the SMF 132. For example, a 5GS mobility management (5GMM) protocol can operate between the UE 110 and the AMF 131, and be used as a transport protocol. A 5GSM message of a 5GSM protocol can be piggybacked in a 5GMM transport message. For example, the 5GSM message can be transmitted in an information element (IE) in the 5GMM transport message.

The 5GSM procedures can include a UE-requested PDU session establishment process for establishing a PDU session, a network-initiated PDU session modification process (may be requested by a UE), and a network-initiated PDU session release process (may be requested by a UE).

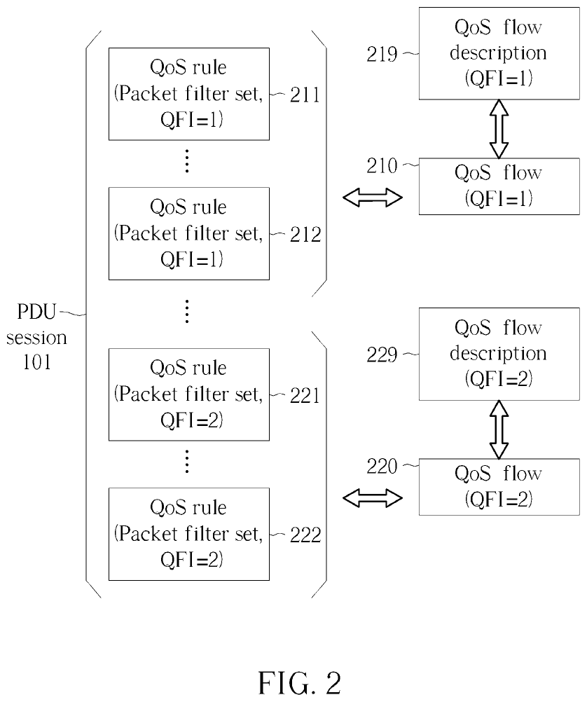

FIG. 2 shows an example of the PDU session 101 according to an embodiment of the disclosure. The PDU session 101 can be of a PDU session type of IPV4, IPv6, IPv4v6, Ethernet, or the like. The PDU session 101 can include one or more quality of service (QOS) flows 210 to 220. Each of the QoS flows 210 to 220 has a QoS flow identifier (QFI) and is associated with one or more QoS rules, and may further be associated with a QoS flow description. For example, the QoS flow 210 of QFI=1 is associated with QoS rules 211 to 212, and may further be associated with a QoS flow description 219. The QoS flow 220 of QFI=2 is associated with QoS rules 221 to 222, and may further be associated with a QoS flow description 229. The QoS rules 211 to 212 and 221 to 222 and the QoS flow descriptions 219 to 229 are crucial as they determine how different types of data are treated within the communication system 100, ensuring that each data packet gets the appropriate level of service.

The QoS rules of the PDU session 101 can be signaled from the core network 130 when the PDU session 101 is established or modified, or they can be derived locally using a reflective QoS scheme. Each signaled QoS rule, such as the QoS rules 211 to 212 and 221 to 222, can include several components. These components include an indication of whether the QOS rule is a default QoS rule, a QoS rule identifier (QRI), and a QoS Flow Identifier (QFI) corresponding to the associated QoS flow. Additionally, each signaled QoS rule may further include a set of packet filters (a packet filter set), and a precedence value. The packet filter set can include zero or more packet filters (other than a match-all packet filter) for uplink or downlink. These packet filters are used to classify data units into the respective QoS flows. A default QoS rule may include a match-all packet filter, and typically be assigned with the lowest precedence. During a filtering operation, the filter sets are used according to the precedence of the respective QoS rules. Packets not matching other packet filters can be collected into the QoS flow associated with the default QoS rule which includes the match-all packet filter. It should be noted that the default QoS rule should exist throughout the lifetime of the PDU session 101. Within the 5G System, a QoS Flow associated with the default QoS rule is required to be established for a PDU Session and remains established throughout the lifetime of the PDU Session. The default QoS rule is a special QoS rule that is applied to all data flows that do not have an explicitly associated QoS rule. It is identified by a Default QoS Rule Identifier (DQR) set to 1. The default QoS rule is essential for maintaining the basic level of service quality for a PDU session. It provides a basic level of QoS that ensures that all data is delivered successfully. The specific parameters of the default QoS rule are defined by the 3GPP specifications.

The QoS flow descriptions 219 to 229 of the PDU session 101 can be provided from the core network 130 when the PDU session 101 is established or modified. Each QoS flow description can include a QFI corresponding to the respective associated QoS flow. Each QoS flow description can further include a 5G QoS identifier (5QI) if the respective QFI is not the same as the 5QI of the respective QoS flow identified by the respective QFI. A 5QI can be used as an index to determine a set of QoS parameters (referred to as 5G QoS characteristics) in a mapping table providing a mapping between 5QI values and respective QoS characteristics. The 5G QoS characteristics indicated by a 5QI can describe a packet forwarding treatment that the respective QoS flow can receive, for example, between the UE 110 and the UPF 133. As defined in the 3 5G standard (TS 23.501), QFI (QOS Flow Identifier) and 5QI (5G QoS Identifier) are both identifiers used to describe QoS (Quality of Service). QFI and 5QI are important tools for describing QoS in 5G networks. QFI is used to identify QoS flows, and 5QI is used to identify QoS characteristics. The relationship between QFI and 5QI is as follows: (1) Each QoS flow is assigned a QFI; (2) A QFI can be used to map to 5QI when 5QI is not present in the QoS Flow description; QFI can be used to differentiate between different QoS flows within a PDU session. For example, a high-priority flow could be assigned one QFI, and a low-priority flow could be assigned another QFI. 5QI can be used to apply QoS policies to packets. For example, traffic with high latency tolerance could be assigned to a 5QI with lower latency requirements. QFI is a unique identifier within the scope of a PDU session. Different QoS flows in the same PDU session cannot use the same QFI. 5QI is a globally unique identifier. QoS flows in different PDU sessions can use the same 5QI.

The mapping table providing a mapping between 5QI values and respective QoS characteristics can be, for example, a standardized table, a preconfigured table, or a dynamically signaled table from the core network 130. An example of a standardized mapping table, “Table 5.7.4-1: Standardized 5QI to QoS characteristics mapping” is described in the 3GPP standard 23.501, Technical Specification Group Services and System Aspects; System architecture for the 5G System (5GS); Stage 2 (Release 16).

In the table mapping 5QI values with QoS characteristics, each 5QI value can have a resource type attribute (also referred to as a guaranteed bit rate (GBR) attribute). The resource type attribute can include a value of GBR, non-GBR, or delay critical GBR. In an embodiment, based on the resource attribute, a QoS flow corresponding to a 5QI can be categorized as a GBR QOS flow (including delay critical GBR flow) or a non-GBR QOS flow. For example, a QoS flow of a 5QI having a GBR or delay critical GBR attribute can be categorized as a GBR QoS flow, while a QoS flow of a 5QI having a non-GBR attribute can be categorized as a non-GBR QoS flow. Typically, a GBR QoS flow can be served with a guaranteed flow bit rate (GFBR), while a non-GBR QoS flow does not have a GFBR.

When a QoS flow is a GBR QoS flow, the QoS flow description associated with the GBR QOS flow should include the following mandatory and necessary parameters:
1) GFBR uplink: Guaranteed flow bit rate (GFBR) for uplink (UL);
2) GFBR downlink: Guaranteed flow bit rate (GFBR) for downlink (DL);
3) MFBR uplink: Maximum flow bit rate (MFBR) for UL; and
4) MFBR downlink: Maximum flow bit rate (MFBR) for DL.

In addition, a QoS rule of the PDU session 101 may be associated with no QoS flow description. For example, when the UE 110 receives a PDU SESSION MODIFICATION COMMAND message from the SMF 132 and the received PDU SESSION MODIFICATION COMMAND message includes a flow description operation “Delete existing QoS flow description” configured to delete the QoS flow description 219, the QoS flow description 219 would be deleted and the QoS rule 211 would be associated with no QoS flow description accordingly. After the QoS flow description 219 is deleted, the QoS rule 211 is still associated with the QoS flow 210 because the QoS rule 211 and the QoS flow 210 have the same QFI.

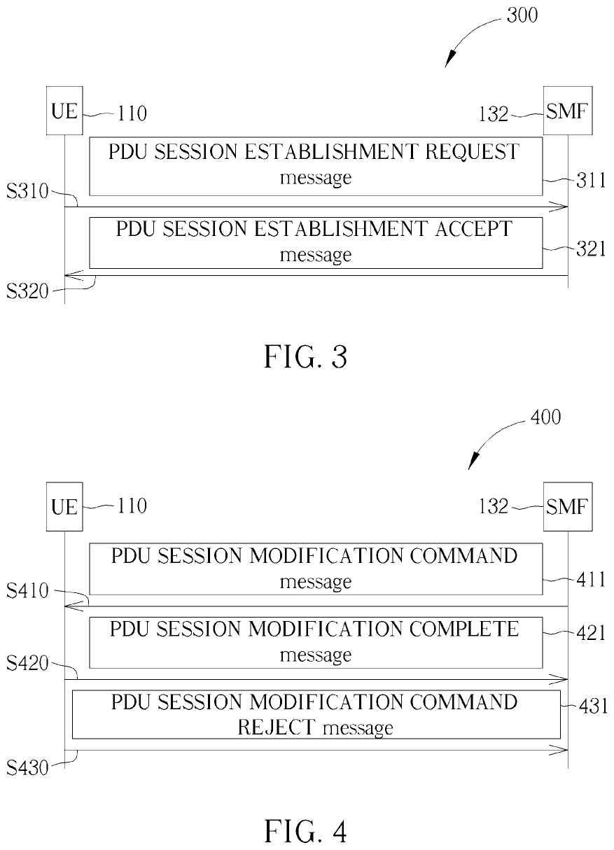

FIG. 3 shows an example UE-requested PDU session establishment procedure 300. The UE-requested PDU session establishment procedure 300 can include steps S310 to S320, and be performed between the UE 110 and the SMF 132 to establish a target PDU session.

At step S310, a PDU SESSION ESTABLISHMENT REQUEST message 311 can be transmitted from the UE 110 to the SMF 132. The PDU SESSION ESTABLISHMENT REQUEST message 311 may include an associated PDU session ID, a PDU session type information element (IE), a session and service continuity (SSC) mode IE, a maximum number of packet filters the UE 110 supports, a requested data network name (DNN), and the like.

At step S320, a PDU SESSION ESTABLISHMENT ACCEPT message 321 can be transmitted from the SMF 132 to the UE 110. The PDU SESSION ESTABLISHMENT ACCEPT message 321 can include an authorized QoS rules IE that is set to QoS rules authorized to the target PDU session. In addition, the PDU SESSION ESTABLISHMENT ACCEPT message 321 may or may not include a QoS flow descriptions IE set to authorized QoS flow descriptions. In an example, the QoS flow descriptions IE is set to authorized QoS flow descriptions and provided when the authorized QoS rules IE indicate at least one GBR QoS flow, or a QFI is not the same as a 5QI of a QoS flow identified by the QFI.

The UE 110 can store the authorized QoS rules, and the authorized QoS flow descriptions (if available) for the target PDU session. In addition, the UE 110 can verify the authorized QoS rules and the authorized QoS flow descriptions provided in the PDU SESSION ESTABLISHMENT ACCEPT message 321 for different types of errors.

The PDU session modification procedure is a critical process that allows the network to adapt to changing conditions and demands. By dynamically adjusting the QoS rules 211 to 212 and 221 to 222 and the QoS flow descriptions 219 to 229, the communication system 100 can prioritize critical data, optimize resource allocation, and maintain overall network performance. This means that the most important data can be transmitted first, resources can be allocated where they are most needed, and the network can continue to function optimally even under changing conditions. By prioritizing critical data, optimizing resource allocation, and adapting to dynamic demands, PDU sessions empower 5G networks to deliver the seamless connectivity and high-performance experience that users crave. The PDU session modification procedure may be requested by the SMF 132 or by the UE 110.

FIG. 4 shows an example network-requested PDU session modification procedure 400. The network-requested PDU session modification procedure 400 can include steps S410 to S420 (or S430), and be performed by the UE 110 and the SMF 132 to modify an existing PDU session. The SMF 132 can proactively initiate the network-requested PDU session modification procedure 400. In another embodiment, the network-requested PDU session modification procedure 400 can be performed in response to a request from the UE 110 to modify the existing PDU session.

At step S410, a PDU SESSION MODIFICATION COMMAND message 411 can be transmitted from the SMF 132 to the UE 110. The PDU SESSION MODIFICATION COMMAND message 411 may include an authorized QoS rules IE set to authorized QoS rules that are to be modified or created at the UE 110. The PDU SESSION MODIFICATION COMMAND message 411 may include an authorized QoS flow descriptions IE set to authorized QoS flow descriptions that are to be modified or created at the UE 110. In an example, when a new authorized QoS rule for a new QoS flow is to be created, an authorized QoS flow description for that new QoS flow can be set in the authorized QoS flow descriptions IE if the newly created authorized QoS rules are for a new GBR QoS flow, or a QFI of the new QoS flow is not the same as a 5QI of the QoS flow identified by the QFI.

At step S420, the UE 110 can transmit a PDU SESSION MODIFICATION COMPLETE message 421 to the SMF 132. Or, at step S430, the UE 110 can transmit a PDU SESSION MODIFICATION COMMAND REJECT message 431 with a 5GSM cause IE indicating a reason for rejecting the PDU session modification. For example, the 5GSM cause IE may include a value of #26, insufficient resources; #43, invalid PDU session identity; #44, semantic error in packet filter (s); #45, syntactical error in packet filter (s); #83, semantic error in the QoS operation; #84, syntactical error in the QoS operation; or the like.

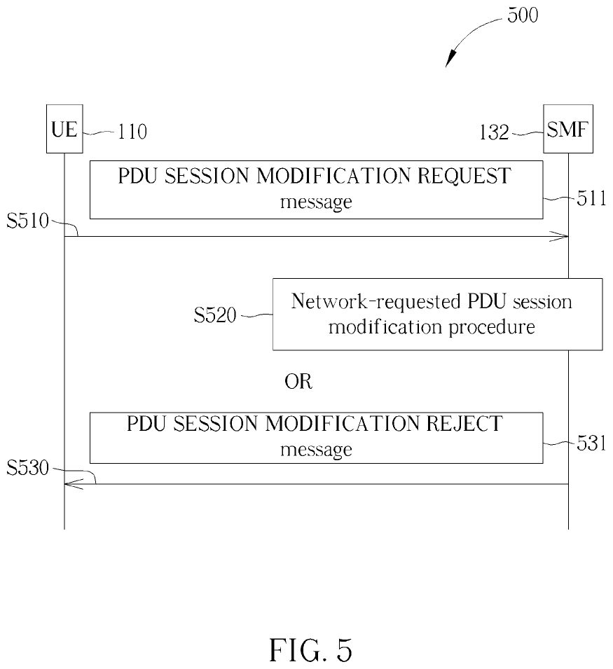

FIG. 5 shows an example UE-requested PDU session modification procedure 500. The UE-requested PDU session modification procedure 500 can include steps S510 to S520 (or S530), and be performed by the SMF 132 and the UE 110 to modify an existing PDU session. The UE 110 can proactively initiate the PDU session modification procedure.

At step S510, a PDU SESSION MODIFICATION REQUEST message 511 can be transmitted from the UE 110 to the SMF 132.

At step S520, the SMF 132 performs the network-requested PDU session modification procedure 400 in response to receiving the PDU SESSION MODIFICATION REQUEST message 511. Or, at step S530, the SMF 132 can transmit a PDU SESSION MODIFICATION REJECT message 531 with a 5GSM cause IE indicating a reason for rejecting the PDU session modification. For example, the 5GSM cause IE may include a value of #43, Invalid PDU session identity; #95, Protocol Error or Semantically incorrect message; or the like.

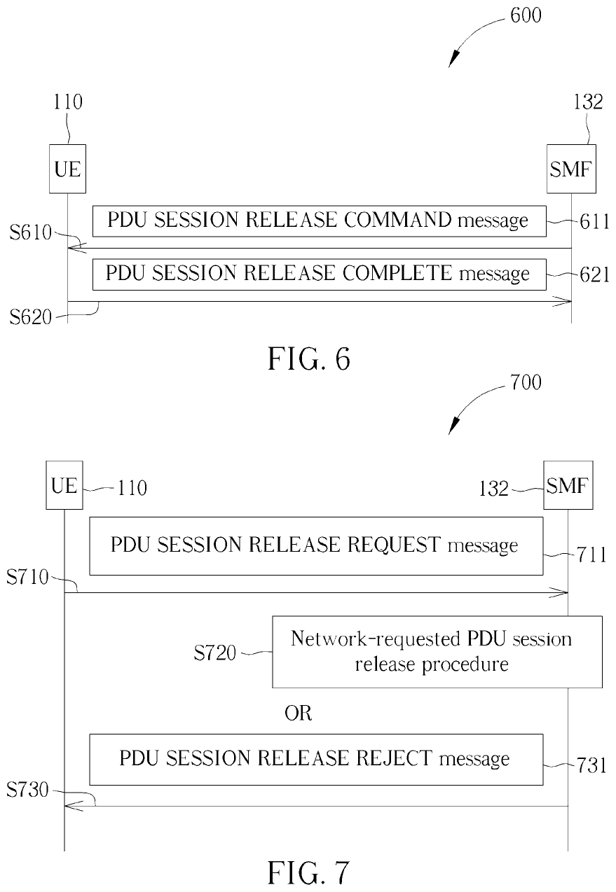

FIG. 6 shows an example network-requested PDU session release procedure 600. The network-requested PDU session release procedure 600 can include steps S610 to S620, and be performed by the UE 110 and the SMF 132 to release an existing PDU session. The SMF 132 can proactively initiate the network-requested PDU session release procedure 600. In another embodiment, the network-requested PDU session release procedure 600 can be performed in response to a request from the UE 110 to release the existing PDU session.

At step S610, a PDU SESSION RELEASE COMMAND message 611 can be transmitted from the SMF 132 to the UE 110. The PDU SESSION RELEASE COMMAND message 611 may carry a 5GSM cause IE to indicate a reason for releasing the existing PDU session. The 5GSM cause IE may indicate one of the following cause values: #8, operator determined barring; #26, insufficient resources; #29, user authentication or authorization failed; #36, regular deactivation; #38, network failure; or the like.

At step S620, the UE 110 may transport a PDU SESSION RELEASE COMPLETE message 621 in response to receiving the PDU SESSION RELEASE COMMAND message 611.

FIG. 7 shows an example UE-requested PDU session release procedure 700. The UE-requested PDU session release procedure 700 can include steps S710 to S720 (or S731), and be performed by the SMF 132 and the UE 110 to release an existing PDU session. The UE 110 can proactively initiate the UE-requested PDU session release process 700.

At step S710, a PDU SESSION RELEASE REQUEST message 711 can be transmitted from the UE 110 to the SMF 132. The PDU SESSION RELEASE REQUEST message 711 may carry a 5GSM cause IE to indicate a reason for releasing the existing PDU session. The 5GSM cause IE may indicate one of the following cause values: #36, regular deactivation; #41, Semantic error in the TFT operation; #42, Syntactical error in the TFT operation; #44, Semantic errors in packet filter(s); #45, Syntactical errors in packet filter(s); or the like.

At step S720, the SMF 132 may perform the network-requested PDU session release procedure 600 in response to receiving the PDU SESSION RELEASE REQUEST message 711. Or, at step S730, the SMF 132 can transmit a PDU SESSION RELEASE REJECT message 731 with a 5GSM cause IE indicating a reason for rejecting the PDU session release. The 5GSM cause IE may indicate one of the following cause values: #35, PTI already in use; #43, Invalid PDU session identity; #95 to #111, protocol errors; or the like.

When the SMF 132 sends the PDU SESSION MODIFICATION COMMAND message 411 (as shown in FIG. 4) to the UE 110, the PDU SESSION MODIFICATION COMMAND message 411 may include a rule operation or a flow description operation. The “rule operation” refers to the actions taken on QoS rules (e.g., the QoS rules 211 to 212 and 221 to 222) within the communication system 100. The “flow description operation” refers to the actions taken on the QoS flow descriptions (e.g., the QoS flow descriptions 219 to 229) within the communication system 100. The rule operation can be “Create new QoS rule”, “Delete existing QoS rule”, “Modify existing QoS rule and add packet filters”, “Modify existing QoS rule and replace all packet filters”, “Modify existing QoS rule and delete packet filters” or “Modify existing QoS rule without modifying packet filters”. The flow description operation can be “Create new QoS flow description”, “Delete existing QoS flow description” or “Modify existing QoS flow description”. When the rule operation is “Create new QoS rule”, a new QoS rule is created for the specified QoS flow. When the rule operation is “Delete existing QoS rule”, an existing QoS rule for the specified QoS flow is deleted. When the rule operation is “Modify existing QoS rule and add packet filters”, the existing QoS rule for the specified QoS flow is modified by adding new packet filters. When the rule operation is “Modify existing QoS rule and replace all packet filters”, the existing QoS rule for the specified QoS flow is modified by replacing all existing packet filters with the new packet filters. When the rule operation is “Modify existing QoS rule and delete packet filters”, the existing QOS rule for the specified QoS flow is modified by deleting the specified packet filters. When the rule operation is “Modify existing QoS rule without modifying packet filters”, the existing QoS rule for the specified QoS flow is modified without changing the packet filters. When the flow description operation is “Create new QoS flow description”, a QOS flow description with one or more parameters specified by the flow description operation will be created. When the flow description operation is “Delete existing QoS flow description”, a QoS flow description specified by the flow description operation will be removed. When the flow description operation is “Modify existing QoS flow description”, the parameters of a QoS flow description specified by the flow description operation will be modified.

When the SMF 132 sends the PDU SESSION MODIFICATION COMMAND message 411 to the UE 110, or when the UE 110 sends the PDU SESSION MODIFICATION REQUEST message 511 to the SMF 132, a PDU session modification procedure can be performed to modify an existing PDU session, and a QoS rule resulted from the modification of the PDU session can be referred as “a resulting QoS rule” or “a resulted QoS rule”. When the rule operation is “Create new QoS rule”, “Modify existing QoS rule and add packet filters”, “Modify existing QoS rule and replace all packet filters”, “Modify existing QoS rule and delete packet filters” or “Modify existing QoS rule without modifying packet filters”, there is no QoS flow description with a QFI corresponding to the QFI of the resulting QoS rule and the UE 110 determines, by using the QoS rule's QFI as the 5QI, that there is a resulting QoS rule for a GBR QOS flow (as described in 3GPP TS 23.501 table 5.7.4-1). In other words, when the rule operation is performed, the UE 110 uses the QFI of the resulting QoS rule as the 5QI of the resulting QoS rule, and the UE 110 determines that the resulting QoS rule is associated with GBR QoS flow of the PDU session 101 according to the 5QI of the resulting QoS rule and that the resulting QoS rule is associated with no QoS flow description.

When the flow description operation is “Delete existing QoS flow description”, and the UE 110 determines, by using the QoS rule's QFI as the 5QI, that there is a resulting QoS rule for a GBR QoS flow (as described in 3GPP TS 23.501 table 5.7.4-1) with a QFI corresponding to the QFI of the QoS flow description that is deleted (i.e. there is no associated QoS flow description with the same QFI). In other words, when the flow description operation is performed, the UE 110 uses the QFI of the resulting QoS rule as the 5QI of the resulting QoS rule, and the UE 110 determines that the resulting QoS rule is associated with GBR QoS flow of the PDU session 101 according to the 5QI of the resulting QoS rule and that the resulting QoS rule is associated with no QoS flow description.

As above descripted, when a QoS flow is a GBR QoS flow, the QoS flow description associated with the GBR QoS flow should include the mandatory and necessary parameters: GFBR uplink, GFBR downlink, MFBR uplink and MFBR downlink. Therefore, if the UE 110 determines that the resulting QoS rule is associated with GBR QoS flow of the PDU session 101 according to the 5QI of the resulting QoS rule and that the resulting QoS rule is associated with no QoS flow description, the resulting QoS rule should be deleted or the PDU session 101 should be released. In detail, when the QoS rule resulted from modification of the PDU session (i.e., the resulting QoS rule) is associated with a GBR QOS flow of the PDU session and associated with no QoS flow description and the resulting QoS rule is a default QoS rule, the UE 110 can initiate a PDU session release procedure by sending the PDU SESSION RELEASE REQUEST message 711 to the core network 130. When the resulting QoS rule is associated with the GBR QoS flow of the PDU session and associated with no QOS flow description and the resulting QoS rule is not the default QoS rule, the UE 110 sends the PDU SESSION MODIFICATION REQUEST message 511 to the core network 130 to delete the resulting QoS rule.

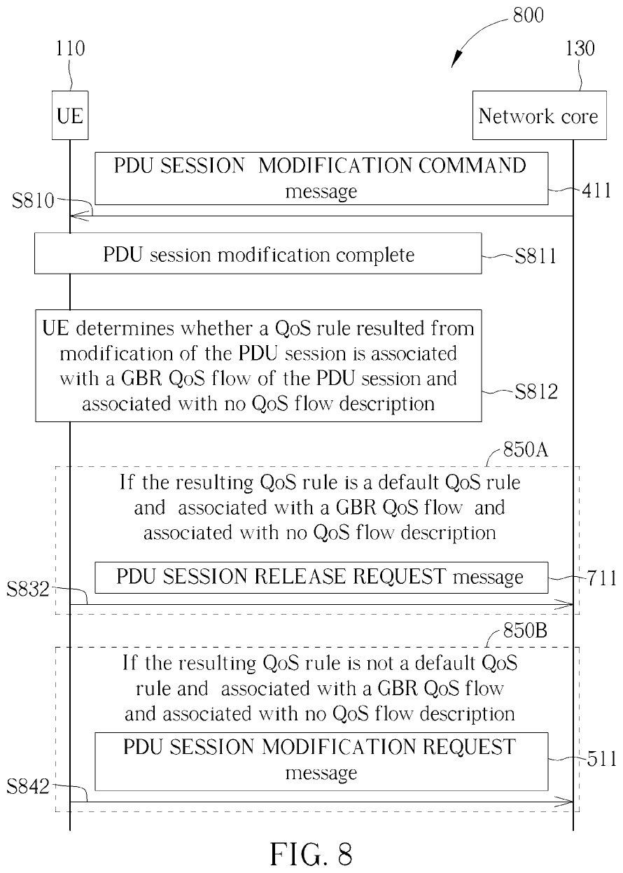

FIG. 8 shows a QoS rule handling process 800 according to an embodiment of the disclosure. The communication system 100 in the FIG. 1 is used as an example for explanation of the QoS rule handling process 800. Accordingly, the QoS rule handling process 800 can be performed between the UE 110 and the core network 130.

At step S810, the core network 130 sends the PDU SESSION MODIFICATION COMMAND message 411 to the UE 110 to command the UE 110 to perform the network-requested PDU session modification procedure 400.

At step S811, the modification of the PDU session, which is initiated by the network core 130 by sending the PDU SESSION MODIFICATION COMMAND message 411 to the UE 110 at step S810, is completed.

At step S812, the UE 110 determines whether a QoS rule that resulted from the modification of the PDU session completed at step S811 is associated with a GBR QOS flow of the PDU session 101 and associated with no QoS flow description.

Upon the determination of the UE 110 at step S812, a QoS rule handling operation can subsequently be conducted. Corresponding to different scenarios (e.g., scenarios of 850A and 850B), different groups of steps can be conducted in the QoS rule handling operation.

In a first scenario of 850A, when the resulting QoS rule is a default QoS rule and associated with a GBR QoS flow and associated with no QoS flow description, a step S832 can be performed. At step S832, the UE 110 sends the PDU SESSION RELEASE REQUEST message 711 with 5GSM cause #84 “syntactical error in the QoS operation to the core network 130.

In a second scenario of 850B, when the resulting QoS rule is not a default QoS rule and associated with a GBR QoS flow and associated with no QoS flow description, a step S842 can be performed. At step S842, the UE 110 sends the PDU SESSION MODIFICATION REQUEST message 511 to the core network 130 to request the core network 130 to delete the resulting QoS rule.

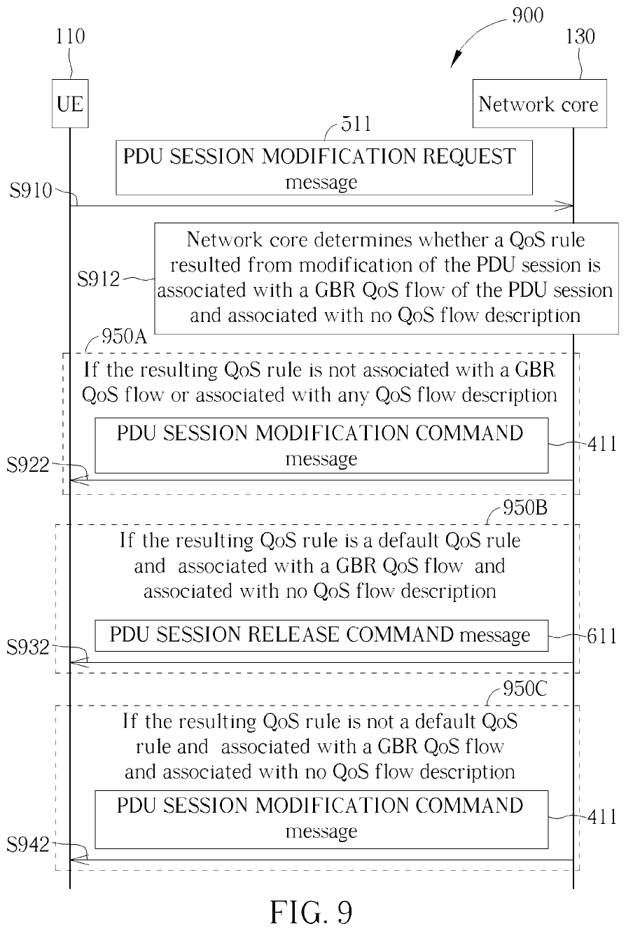

FIG. 9 shows another QoS rule handling process 900 according to an embodiment of the disclosure. The communication system 100 in the FIG. 1 is used as an example for explanation of the QoS rule handling process 900. Accordingly, the QoS rule handling process 900 can be performed between the UE 110 and the core network 130.

At step S910, the UE 110 sends the PDU SESSION MODIFICATION REQUEST message 511 to the core network 130 to request the core network 130 to perform the UE-requested PDU session modification procedure 500.

At step S912, the network core 130 determines whether a QoS rule resulted from modification of the PDU session is associated with a GBR QoS flow of the PDU session and associated with no QoS flow description.

Upon the determination of the network core 130 at step S912, a QoS rule handling operation can subsequently be conducted. Corresponding to different scenarios (e.g., scenarios of 950A, 950B, and 950C), different groups of steps can be conducted in the QoS rule handling operation.

In a first scenario of 950A, when the resulting QoS rule is not associated with a GBR QoS flow or associated with any QoS flow description, a step S922 can be performed. At step S922, the network core 130 performs the UE-requested PDU session modification procedure 500 according to the PDU SESSION MODIFICATION REQUEST message 511, and sends the PDU SESSION MODIFICATION COMMAND message 411 to the UE 110 without deleting a resulting QoS rule.

In a second scenario of 950B, when the resulting QoS rule is a default QoS rule and associated with a GBR QOS flow and associated with no QoS flow description, a step S932 can be performed. At step S932, the network core 130 sends the PDU SESSION RELEASE COMMAND message 611 to the UE 110 to command the UE 110 to release the PDU session 101.

In a third scenario of 950C, when the resulting QoS rule is not a default QoS rule and associated with a GBR QoS flow and associated with no QoS flow description, a step S942 can be performed. At step S942, the network core 130 sends the PDU SESSION MODIFICATION COMMAND message 411 to the UE 110 to command the UE 110 to delete the resulting QoS rule.

The PDU SESSION ESTABLISHMENT REQUEST message 311, the PDU SESSION ESTABLISHMENT ACCEPT message 321, the PDU SESSION MODIFICATION COMMAND message 411, the PDU SESSION MODIFICATION COMPLETE message 421, the PDU SESSION MODIFICATION COMMAND REJECT message 431, the PDU SESSION MODIFICATION REQUEST message 511, the PDU SESSION MODIFICATION REJECT message 531, the PDU SESSION RELEASE COMMAND message 611, the PDU SESSION RELEASE COMPLETE message 621, and the PDU SESSION RELEASE REQUEST message 711 can be non-access stratum (NAS) messages, more particularly can be fifth-generation session management (5GSM) messages.

To sum up, the disclosure provides a user equipment (UE) and a method of handling quality of service (QoS) rules of a protocol data unit (PDU) session. When a QoS rule resulted from modification of the PDU session is associated with the GBR QoS flow of the PDU session and associated with no QoS flow description and the QoS rule is a default QoS rule, a PDU session release procedure is initiated. Since the default QoS rule should exist throughout the lifetime of the PDU session, if the QoS rule resulted from modification of the PDU session is associated with the GBR QOS flow of the PDU session and associated with no QoS flow description and the QoS rule is a default QoS rule, the communication system releases the PDU session instead of deleting the default QoS rule. Accordingly, each PDU session in the communication system has the default QoS rule, and the communication system is maintained and operated correctly.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling quality of service (QOS) rules of a protocol data unit (PDU) session, comprising:
receiving a non-access stratum (NAS) message for modifying the PDU session from a core network by a user equipment (UE);
determining whether a QoS rule resulted from modification of the PDU session is associated with a guaranteed bit rate (GBR) QOS flow of the PDU session and associated with no QoS flow description; and
when the QoS rule resulted from the modification of the PDU session is associated with the GBR QOS flow of the PDU session and associated with no QoS flow description and the QoS rule is a default QoS rule, initiating a PDU session release procedure by sending a PDU SESSION RELEASE REQUEST message from the UE to the core network.

2. The method of claim 1, further comprising:
when the QoS rule resulted from the modification of the PDU session is associated with the GBR QOS flow of the PDU session and associated with no QoS flow description and the QoS rule is not the default QoS rule, sending a PDU SESSION MODIFICATION REQUEST message from the UE to the core network to delete the QoS rule.

3. The method of claim 1, wherein the QoS rule resulted from the modification of the PDU session is determined to be associated with the GBR QoS flow according to a 5G QOS identifier (5QI) of the QoS rule.

4. The method of claim 3, further comprising:
determining the 5QI of the QoS rule is a QoS flow identifier (QFI) of the QoS rule.

5. The method of claim 1, wherein the NAS message is a fifth-generation session management (5GSM) message.

6. The method of claim 1, wherein the NAS message is a PDU SESSION MODIFICATION COMMAND message.

7. The method of claim 6, wherein the PDU SESSION MODIFICATION COMMAND message comprises a rule operation, and the rule operation is “Create new QoS rule”, “Modify existing QoS rule and add packet filters”, “Modify existing QoS rule and replace all packet filters”, “Modify existing QoS rule and delete packet filters” or “Modify existing QoS rule without modifying packet filters”.

8. The method of claim 6, wherein the PDU SESSION MODIFICATION COMMAND message comprises a flow description operation, and the flow description operation is “Delete existing QoS flow description”.

9. A method of handling quality of service (QOS) rules of a protocol data unit (PDU) session, comprising:
receiving a non-access stratum (NAS) message for modifying the PDU session from a user equipment (UE) by a core network;
determining whether a QoS rule resulted from modification of the PDU session is associated with a guaranteed bit rate (GBR) QoS flow of the PDU session and associated with no QoS flow description; and
when the QoS rule resulted from the modification of the PDU session is associated with the GBR QOS flow of the PDU session and associated with no QoS flow description and the QoS rule is a default QoS rule, initiating a PDU session release procedure by sending a PDU SESSION RELEASE COMMAND message from the core network to the UE.

10. The method of claim 9, wherein the QoS rule resulted from the modification of the PDU session is determined to be associated with the GBR QoS flow according to a 5G QoS identifier (5QI) of the QoS rule.

11. The method of claim 9, further comprising:
when the QoS rule resulted from the modification of the PDU session is associated with the GBR QoS flow of the PDU session and associated with no QoS flow description and the QoS rule is not the default QoS rule, sending a PDU SESSION MODIFICATION COMMAND message from the core network to the UE to delete the QoS rule.

12. The method of claim 9, wherein the NAS message is a fifth-generation session management (5GSM) message.

13. The method of claim 9, wherein the NAS message is a PDU SESSION MODIFICATION REQUEST message.

14. The method of claim 13, wherein the PDU SESSION MODIFICATION REQUEST message comprises a rule operation, and the rule operation is “Create new QoS rule”, “Modify existing QoS rule and add packet filters”, “Modify existing QoS rule and replace all packet filters”, “Modify existing QoS rule and delete packet filters” or “Modify existing QoS rule without modifying packet filters”.

15. The method of claim 13, wherein the PDU SESSION MODIFICATION REQUEST message comprises a flow description operation, and the flow description operation is “Delete existing QoS flow description”.

16. A user equipment (UE), comprising:
a transceiver configured to receive signals from a core network and transmit signals to the core network; and
a processor coupled to the transceiver and configured to:
control the transceiver to receive a non-access stratum (NAS) message for modifying a protocol data unit (PDU) session from the core network;
determine whether a QoS rule resulted from modification of the PDU session is associated with a guaranteed bit rate (GBR) QoS flow of the PDU session and associated with no QoS flow description; and
when the QoS rule resulted from the modification of the PDU session is associated with the GBR QoS flow of the PDU session and associated with no QoS flow description and the QoS rule is a default QoS rule, initiate a PDU session release procedure by controlling the transceiver to send a PDU SESSION RELEASE REQUEST message to the core network.

17. The UE of claim 16, wherein when the QoS rule resulted from the modification of the PDU session is associated with the GBR QoS flow of the PDU session and associated with no QoS flow description and the QoS rule is not the default QoS rule, the processor controls the transceiver to send a PDU SESSION MODIFICATION REQUEST message to the core network to delete the QoS rule.

18. The UE of claim 16, wherein the processor determines that the QoS rule resulted from the modification of the PDU session is associated with the GBR QoS flow according to a 5G QoS identifier (5QI) of the QoS rule.

19. The UE of claim 16, wherein the NAS message is a PDU SESSION MODIFICATION COMMAND message comprising a rule operation, and the rule operation is “Create new QoS rule”, “Modify existing QoS rule and add packet filters”, “Modify existing QoS rule and replace all packet filters”, “Modify existing QoS rule and delete packet filters” or “Modify existing QoS rule without modifying packet filters”.

20. The UE of claim 16, wherein the NAS message is a PDU SESSION MODIFICATION COMMAND message comprising a flow description operation, and the flow description operation is “Delete existing QoS flow description”.
